(19) United States
(12) Patent Application Publication
(10) Pub. No.: US 2002/0184094 A1
(43) Pub. Date: Dec. 5, 2002

(54) Electronic system and method for rewarding participants posting entries on an internet web site

(76) Inventor: Jesse L. Calloway, Concord, NC (US)

Correspondence Address: Jeffrey J. Schwartz, Adams, Schwartz & Evans, P.A., 2180 Two First Union Center, Charlotte, NC, 28282, US

(21) Appl. No.: 09/873,885

(22) Filed: Jun. 4, 2001

(51) Int. Cl. G06F 17/60

(52) U.S. Cl. 705/14; 705/26

(57) ABSTRACT

An electronic system rewards participants posting entries on an Internet Web site. The system includes a Web page with participant entries adapted for being accessed and viewed by visitors of the Web site. The entries are ranked based on predetermined preference criteria. Certain participants are rewarded based on their entry ranking relative to other entries posted on the Web site.

### TECHNICAL FIELD AND BACKGROUND OF THE INVENTION

This invention relates to an electronic system and method for rewarding participants posting entries on an Internet Web site. The invention encourages the publication of useful, interesting, imaginative, and creative material via a global communications network. Participants post entries for a small fee, and are subsequently rewarded based on certain preference criteria, such as the overall number of hits within a fixed period, viewing duration, or popular vote. The reward may include a cash payout, gift certificates, coupons, prizes, or the like. Unlike games of pure chance, the invention rewards participants based on their ability to capture the attention and interest of visitors to the Web site.

### SUMMARY OF THE INVENTION

Therefore, it is an object of the invention to provide an electronic system and method for rewarding participants posting submissions on an Internet Web site.

It is another object of the invention to provide an electronic system and method which promotes and encourages the publication of useful, interesting, imaginative, and creative material.

It is another object of the invention to provide an electronic system and method which rewards participants who submit preferred entries on the Web site.

It is another object of the invention to provide an electronic system and method wherein participants posting entries on the Web site remain eligible for a reward for an indefinite period until a reward is actually received.

It is another object of the invention to provide an electronic system and method wherein participants can purchase features designed to increase the likelihood of receiving a reward.

It is another object of the invention to provide an electronic system and method wherein participants can buy, sell, or trade entries posted on the Web site.

It is another object of the invention to provide an electronic system and method wherein participants can buy, sell, or trade an entire category of entries posted on the Web site.

It is another object of the invention to provide an electronic system and method wherein participants can buy, sell, or trade a percentage ownership in a category of entries posted on the Web site.

It is another object of the invention to provide an electronic system and method which lists or displays descriptive or marketable attributes associated with each entry.

It is another object of the invention to provide an electronic system and method which lists or displays descriptive or marketable attributes associated with each category.

It is another object of the invention to provide an electronic system and method which utilizes an electronic forum to facilitate the exchange/trade of entries among participants.

It is another object of the invention to provide an electronic system and method which utilizes an electronic forum to facilitate the exchange/trade of categories among participants.

It is another object of the invention to provide an electronic system and method which administers and collects administrative fees for completing the exchange/trade of entries.

It is another object of the invention to provide an electronic system and method which administers and collects administrative fees for completing the exchange/trade of categories.

It is another object of the invention to provide an electronic system and method which effects the transfer of ownership of entries consistent with the exchange/trade of entries.

It is another object of the invention to provide an electronic system and method which effects the transfer of ownership of categories consistent with the exchange/trade of categories.

It is another object of the invention to provide an electronic system and method which displays participant-negotiated offers/bids for entries.

It is another object of the invention to provide an electronic system and method which displays participant-negotiated offers/bids for categories.

It is another object of the invention to provide an electronic system and method which facilitates and administers the exchange of prizes, cash or other negotiable items for the trade of entries.

It is another object of the invention to provide an electronic system and method which facilitates and administers the exchange of prizes, cash or other negotiable items for the trade of categories.

These and other objects of the present invention are achieved in the preferred embodiments disclosed below by providing an electronic system for rewarding participants posting entries on an Internet Web site. The system includes a Web page with participant entries adapted for being accessed and viewed by visitors of the Web site. Means are provided for ranking the entries, and/or categories of entries, based on preference criteria determined by the system, and for determining which participants are eligible for a reward based on their entry ranking relative to other entries posted on the Web site. The system utilizes basic programming operable on a computer, and generally known and understood by those skilled in the present art.

According to another preferred embodiment of the invention, the participant entry is a text submission.

According to another preferred embodiment of the invention, the participant entry includes one or more photographs.

According to another preferred embodiment of the invention, the participant entry includes a combination of text and a photograph.

According to another preferred embodiment of the invention, the reward is a cash payout.

According to another preferred embodiment of the invention, the reward is a prize item.

In another embodiment, the invention is an electronic system for rewarding participants posting entries on an Internet Web site. The system includes a Web page with participant entries adapted for being accessed and viewed by visitors of the Web site. Means are provided for ranking the entries based on preference criteria determined by the system, and for determining which participants are eligible for a reward based on their entry ranking relative to other entries posted on the Web site. The preference criteria is entry usage over a fixed period. The term “entry usage” as used herein refers to the number of times a participant's entry is accessed by a viewer.

According to another preferred embodiment of the invention, a multiplier is available for purchase by the participant to increase effective usage of the entry during the fixed period.

According to another preferred embodiment of the invention, a sample entry screen is provided on the Web site and includes a listing of both sample entries and actual participant entries.

According to another preferred embodiment of the invention, means are provided for electronically monitoring and displaying the usage of each entry.

According to another preferred embodiment of the invention, means are provided for electronically monitoring and displaying the usage of each category.

In yet another embodiment, the invention is an electronic system for rewarding participants posting entries on an Internet Web site. The system includes a Web page with participant entries adapted for being accessed and viewed by visitors of the Web site. Means are provided for ranking the entries based on preference criteria determined by the system, and for determining which participants rank in the top 100 for entry usage during the fixed period. Those participants ranking in the top 100 are eligible for a reward based on their entry ranking relative to other entries posted on the Web site.

In yet another embodiment, the invention is a method for rewarding participants posting entries on an Internet Web site. The method includes the step of providing a Web page with participant entries adapted for being accessed and viewed by visitors of the Web site. The entries are ranked based on predetermined preference criteria. Certain participants are then rewarded based on their entry ranking relative to other entries posted on the Web site.

According to another preferred embodiment of the invention, the method includes collecting a posting payment from participants posting entries on the Web site.

According to another preferred embodiment of the invention, the method includes collecting a usage payment from viewers to allow access to the Web site.

According to another preferred embodiment of the invention, the step of ranking the entries comprises ranking the entries based on entry usage over a fixed period.

According to another preferred embodiment of the invention, the method includes making those participants with entries ranking in the top 100 for usage eligible for receiving a reward.

According to another preferred embodiment of the invention, the method includes allocating a percentage of the posting payment to a payout fund used for rewarding those participants eligible for receiving a reward during a given period.

According to another preferred embodiment of the invention, the step of rewarding participants comprises rewarding certain ones of those participants with entries ranking in the top 100 for usage with a sum-certain cash payout from the payout fund until the payout fund is emptied.

According to another preferred embodiment of the invention, the method includes automatically carrying forward to a succeeding period those participants ranking in the top 100 for usage during a present period and not receiving a cash payout due to insufficiency of the payout fund.

According to another preferred embodiment of the invention, the method includes purchasing a multiplier or other mathematical influence to increase the overall usage of an entry.

According to another preferred embodiment of the invention, the method includes posting the entry on a sample entry screen to increase overall usage.

In yet another embodiment, the invention is a method for rewarding participants posting entries on an Internet Web site. The method includes the step of collecting a posting payment from participants. The participant entries are then posted on a Web page adapted for being accessed and viewed by visitors of the Web site. The entries are then ranked based on predetermined preference criteria. The preference criteria is entry usage over a fixed period. Certain ones of the participants are made eligible for receiving a cash payout based on a level of their entry usage during the fixed period. A percentage of the posting payment is allocated to a payout fund used for rewarding those participants eligible for receiving the payout. The cash payout is then distributed to eligible participants until the payout fund for the fixed period is emptied. For those participants eligible for receiving the payout but not receiving the payout due to insufficiency of the payout fund, those participants are automatically carried forward to a succeeding period.

### BRIEF DESCRIPTION OF THE DRAWINGS

Some of the objects of the invention have been set forth above. Other objects and advantages of the invention will appear as the description proceeds when taken in conjunction with the following drawings, in which:

FIGS. 1-5 are flow diagrams illustrating operation of an electronic system for rewarding participants posting entries on an Internet Web site.

### DESCRIPTION OF THE PREFERRED EMBODIMENT AND BEST MODE

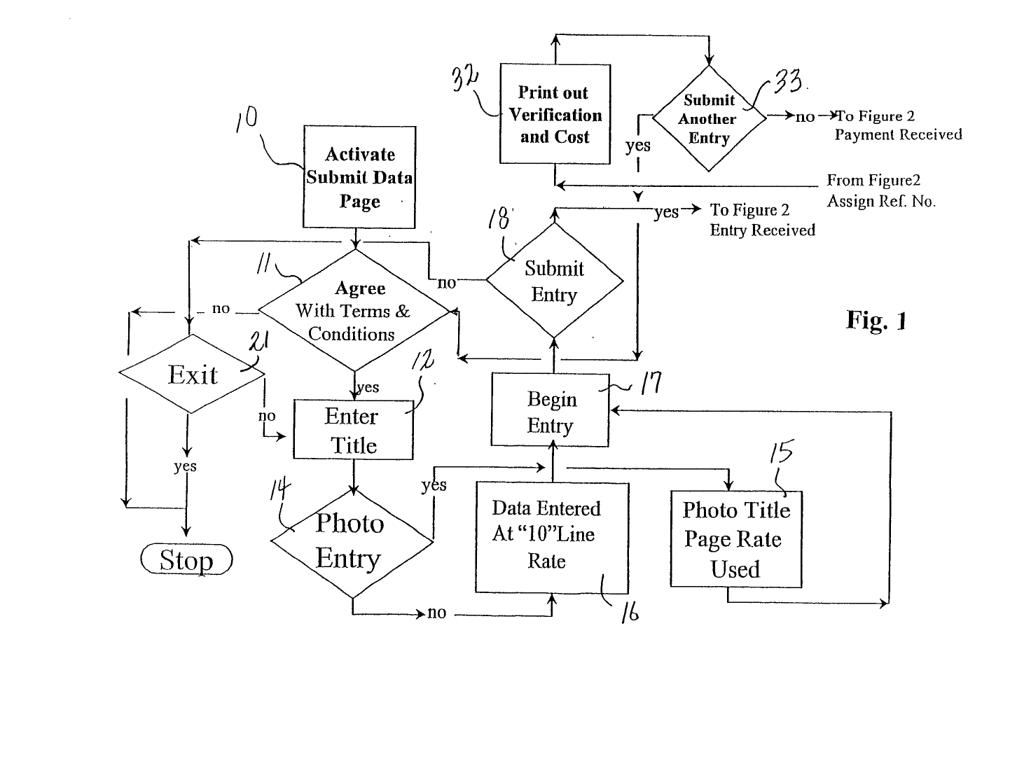

A basic overview of an electronic system according to a preferred embodiment of the invention is described below. The system is intended to reward participants who post informative, imaginative, and/or creative entries on an Internet Web site. The overview is followed by a detailed description of the invention with reference to the drawings, FIGS. 1-5.

A user accesses the Web site via the Internet using, for example, a computer, keyboard and/or mouse and/or graphics tablet, browser software, and communication means, such as a modem or wireless connection. The Web site contains information entries submitted by participants. Each participant pays a small one-time fee for posting an entry on the site. The principal of the invention is to reward participates with a payout based on the number of viewer hits the participant's entry receives within a fixed period. Participants and viewers negotiate the Web site using graphical symbols and menus to carry out commands and select options.

In the example provided, the fee for posting on the Web site is $5.95 for non-photograph entries and $7.95 for entries containing photographs. An information entry may include, for example, general advice, instructions (technical/non-technical), recipes, poems, short stories, opinions, remedies, songs, ideas, photographs, and the like. The entry may be submitted in the form of instruction steps, in one or more paragraphs, such as a short story or essay, a combination of photographs and text, mathematical notation, or any other desired format. Entries are preferably grouped together in categories based on their particular subject matter. The following are examples of entries for posting on the Web site.

### EXAMPLE 1

Category: Cooking

Title: Homemade Yeast Rolls

Ingredients: One cup milk, one cup water, half cup canola oil, one tablespoon salt, three tablespoons sugar, one package dry yeast, three fourths cups warm tap water, one teaspoon sugar, and seven to eight cups of plain sifted flour.

1. Mix first five ingredients together in a saucepan and bring to a boil over medium heat, stirring constantly.

2. Remove from heat and allow to cool.

3. Mix yeast, three fourths cup water and one teaspoon of sugar, together in small bowl and cover with paper towel and allow to rise for twenty-thirty minutes.

4. Place one beaten egg in yeast mixture and add to saucepan mixture.

5. Sift seven cups of flour in a large bowl and add saucepan mixture to flour.

6. Stir approximately fifty strokes with a wooden spoon.

7. Mixture should be soft and doughy but not too sticky and you may add up to one additional cup of flour if needed.

8. Pour dough into large, greased (with oil), plastic covered bowl and allow to rise until doubled in size (approximately 2 hrs).

9. Dip separated pieces of dough, one at a time, in melted margarine and place in greased muffin pans.

10. Bake in preheated oven for about 10 minutes or until golden brown.

Serve hot with butter. The ingredients, listed above, will yield approximately 24 rolls. Any unused roll dough can be stored in the refrigerator, for up to 48 hours, prior to use.

### EXAMPLE 2

Category: Maintenance & Repair

Title: Electrical Receptacle Replacement

1. Prior to beginning any work, make sure that power is removed from the receptacle to be replaced and that it cannot be re-energized while you are performing the replacement. This can be confirmed by using an approved voltage tester.

2. After power is removed and verified, remove the receptacle from the utility box using the appropriate screw driver.

3. Disconnect the wires from the receptacle body. (Typically these wires are black and white.)

4. Remove the new receptacle from package and loosen screws to accommodate new wires.

5. Connect the wires to the new receptacle (black wire to the gold side of the receptacle and white wire to the silver side).

6. Reinstall the receptacle into the utility box, ensuring that no open wiring is exposed, and secure with appropriate screw driver.

7. Reinstall receptacle cover plate.

8. Return to the breaker and re-energize the circuit.

9. Using your approved voltage tester, you should be able to detect the proper voltage.

### EXAMPLE 3

Category: Management

Title: Confronting Undesirable Performance.

Confronting undesirable performance, especially among exempt salaried professionals, can be quite stressful. The key thing to remember, at all times, is to remain objective and focus on the behavior and not the individual. For example, you may begin the conversation by stating exactly what behavioral attributes are unacceptable, and then discuss the desired behavior.

You should always provide very clear examples of unacceptable behavior and steer clear of subjective comments. For example, it serves absolutely no value to make statements such as: “you are not a good supervisor” or “you are not a team player. ” Such comments are typically not based on facts rather, they are pure supposition which should be excluded from the discussion. What should be included in the discussion, however, are very specific examples such as “your area of responsibility has not met its quality or output goal for three consecutive months” or “you did not deliver your portion of the group assignment by the due date.”

At the conclusion of the discussion, the employee should have a clear understanding of the behavior that needs to be corrected, a method that he/she can use to recognize this behavior, and a “plan” whereby on-going feedback (coaching) will be provided by you.

Upon submission of an entry, participants are assigned a reference number which is used to track the number of times their particular entry is accessed by viewers of the Web site. Payouts are based on the number of hits in a given period, e.g., 30 calendar days. At the end of each period, the total usage is calculated for each assigned reference number. Ten percent of all processing revenues received by Web site are allocated to a payout fund used to award $1000 payouts to the top 100 submissions based on usage in any given period. The actual number of participants receiving payouts is based on the sufficiency of the payout fund, and will therefore vary up to 100 in any given period.

At the end of a period, the usage for all entries, except those in the top 100, is reset to zero The usage for entries reaching the top 100, which did not receive payouts due to insufficiency of the payout fund, is rolled over into the next period and totaled with all subsequent usage in that period. This occurs until a payout is actually received by the participant regardless of the number of periods required to reach payout status as long as the entry remains in the top 100 for consecutive periods. Although entries with usage not reaching the top 100 are reset to zero at the end of each period, no additional processing fees are required to keep those reference numbers (and associated entries) active.

For example, if the total revenues allocated to the payout fund in a given period equal $52,000 and a participant's entry is within the top 100 based on usage, then the participant may be one of 51 other participants receiving a $1000 payout. The 52 participant receiving the payout may be selected randomly from the top 100, or based on usage rank. The 48 participants who do not receive a payout due to insufficiency of the payout fund are automatically included in the next period with their entry usage rolled over such that the likelihood of remaining in the top 100 for the next period, and thus receiving a payout, is increased over new participants and those prior participants who failed to make the top 100. As previously indicated, the usage for participants not making the top 100 in a given period is reset to zero for the succeeding period.

Participants are encouraged to view their own entry posted on the Web site. Doing so is free of charge and counts towards increasing the overall usage just as if someone, other than the participant, were to view the submission. Participants may view a submission as many times as desired thereby increasing the usage and thus the opportunity to reach payout status. There are no pre-established panels of editors, literary judges or preset literary criteria to determine who receives a payout for any given period. Payout status is determined based on total usage only.

To further increase usage, participants have the option to purchase a “multiplier.” The multiplier simply multiplies the total actual screen usage by the selected multiple to obtain an effective usage. For example, assume that an entry is viewed on the Web site 100 times during a single period. If the participant had chosen to add a multiplier of 5X, the effective period end usage would be 500 instead of 100. In this case, the likelihood of reaching the top 100 usage level, and qualifying for payout status, is increased by the multiple chosen. Available multiples range from 2X to 10X. Multiples may be purchased during entry of the submission or at any time during the period following entry submission. When reference number usage is reset to zero (occurring at period end for all reference numbers not included in the top 100), the multiplier, unless purchased at a “lock-in” or an extended rate, will be discontinued and must be re-purchased if desired in subsequent periods. A discontinued multiplier will not pass with any purchase, trade, or sell of the reference number.

Another means for increasing entry usage is to add the entry to a “sample entry screen” on the Web site. The sample entry screen includes submissions for viewing by prospective participants. As part of a new participant orientation, participants are given the opportunity to view samples of submissions that are typical of those entered on the Web site. The sample screen includes both non-participant entries and actual participant entries. Each time an actual entry is viewed on the sample screen, usage is increased as though the entry were selected from the normal library of entries. This additional usage credit is summed with all other usage achieved through library viewing.

As indicated above, payout status is determined based on total usage. The higher the usage as a period progresses, the greater the likelihood of achieving payout status at the period end. Thus, entries having high usage during any given period may be desired by those in possession of entries with lesser usage as well as perspective participants who have submitted no entries. In this scenario, users may be encouraged to buy/sell submissions. Consider the following example. Assume that it is November 15th, and the period end-which is when payouts are allocated-is November 30th. Further assume that fictitious entry number 0011 has reached an effective usage of 100,000 hits with the next highest usage entry number 0003 having an effective usage of 20,000 hits. The owner of entry number 0011, who may have paid only a $5.95 entry submission fee, may be willing to sell this entry to a prospective buyer. Suppose that the prospective buyer offers $300 for entry number 0011, based on the likelihood that it will remain among the top 100 entries until it reaches payout status. While the potential exists for the seller's entry to reach pay out status, the seller may be more comfortable taking the guaranteed profits and selling for $300. Assuming the sold entry remains among the top 100 at period end, the buyer would be eligible to receive $1000—the net profit being the difference between what was paid for the entry number and the payout of $1000. A small administrative fee is charged by the Web site to execute a buy or a sell.

Throughout the period, a usage total for each entry may be obtained by visiting a “monitor usage” page of the Web site and entering in the assigned entry reference number. Upon doing so, all reference number usage to that point is displayed to the participant. As a result, each participant can readily track his or her usage position relative to other reference numbers and determine how close the reference number is to reaching payout status.

Operation of the Web Site

Referring now specifically to the flow diagrams of FIGS. 1-5, to submit an entry, a participant activates a “submit data” page at 10 containing terms and conditions for posting entries on the Web site, and for receiving payouts based on usage. The participant is then asked at 11 to accept the terms and conditions of the site in order to proceed. If the participant rejects the terms and conditions, he or she is exited from the Web site. Upon accepting the terms and conditions, the participant is instructed to input an entry title at 12, and is asked at 14 to indicate whether the entry contains a photograph. Entries containing photographs are charged an increased rate for posting, as indicated at 15. Data entries containing 10 or fewer lines are charged a single flat rate, as indicated at 16. The participant inputs the entry at 17. Once entered, the entry must be submitted at 18. If the participant decides not to submit the entry, a prompt is displayed at 21 asking whether the program is to be exited. If the participant chooses not to exit the program, then he or she is returned to the submit entry sequence.

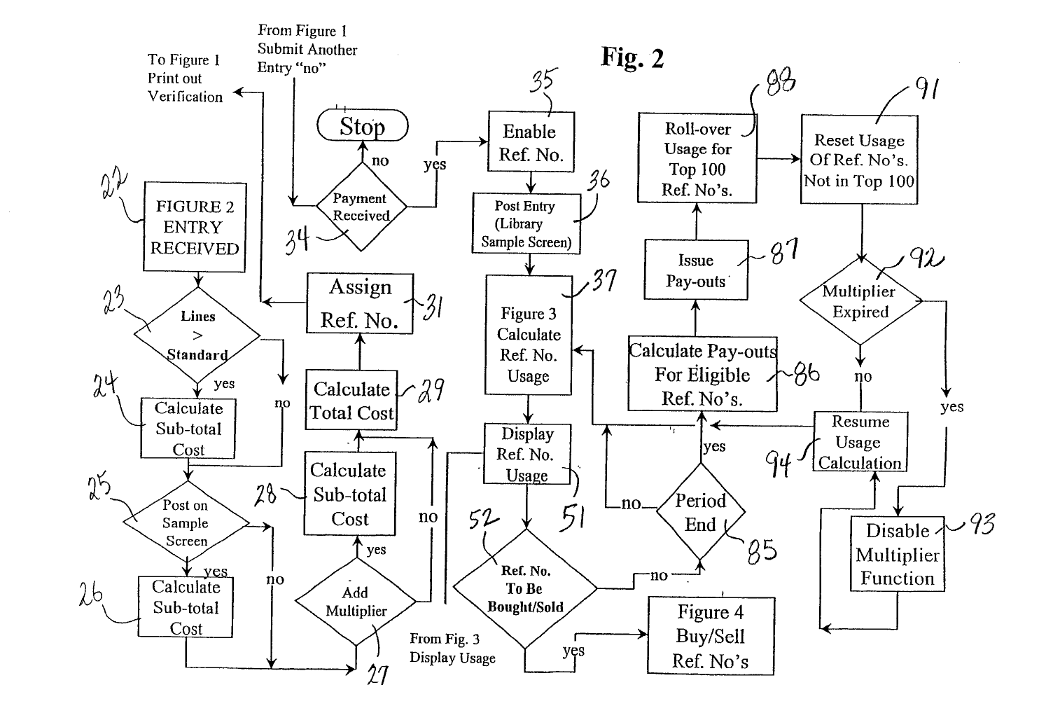

Referring to FIG. 2, once the entry is submitted and received, as indicated at 22, system software determines at 23 whether the number of data lines in the entry exceeds that allowed for the standard 10-line submission cost. If the entry has excess lines, a subtotal cost is calculated at 24 to account for each additional line. The participant is then asked at 25 to indicate whether the entry will be available for access through “sample screen” viewing. Posting on the sample screen gives viewers and prospective participants an opportunity to view other entries, and gives existing participants an opportunity to increase usage credit of their entry when viewed. Upon entering the sample screen, the viewer is presented with a listing of entry samples, some of which will be actual entries, from which to choose a selection or selections to be viewed. The listing of samples may be compiled in response to a category search executed by the viewer. If the viewer chooses an actual entry submission from the sample listing, then the entry is given usage credit. This credit is summed with usage credit generated from normal library usage. An additional subtotal cost is calculated at 26 for participants choosing to post an entry on the sample screen.

In addition to sample screen viewing, participants are given the option at 27 of purchasing a multiplier used to increase the effective total usage of their entry. Preferably, the multipliers consists of integers ranging from 2 to 10. The purchase price for a particular multiplier increases as the value of the multiplier increases. If the participant chooses to purchase a multiplier, a subtotal cost for the multiplier is calculated at 28 and added to the overall cost of the entry. The total cost of the entry, including the subtotals for any additional entry lines, sample screen posting, and multiplier, is then calculated at 29. A reference number is assigned to the entry at 31.

Referring back to FIG. 1, after assignment of the reference number, an entry verification and cost confirmation is provided to the participant in a printout entry form at 32. Typically, the entry form will include the entry, state the total cost of the entry and the reference number, instruct the participant how to submit the entry form, and provide for the participant's signature on the form. To actually submit the entry, the participant must forward the appropriate payment and with the entry signature page form to a specified address. If the participant desires to submit another entry, as indicated at 33, he or she is returned to the submit entry sequence described above.

Referring again to FIG. 2, after payment for the entry is received at 34, the reference number assigned to the entry is enabled at 35. Once the reference number is enabled, the entry is added to the general library (and sample screen, if applicable) at 36 and given a competition start date corresponding to the date of addition to the library. For those participants purchasing space on the sample screen, the entry is also available for access through sample screen viewing. Viewing or “usage” of the entry is conveniently monitored by its reference number, and calculated at 37.

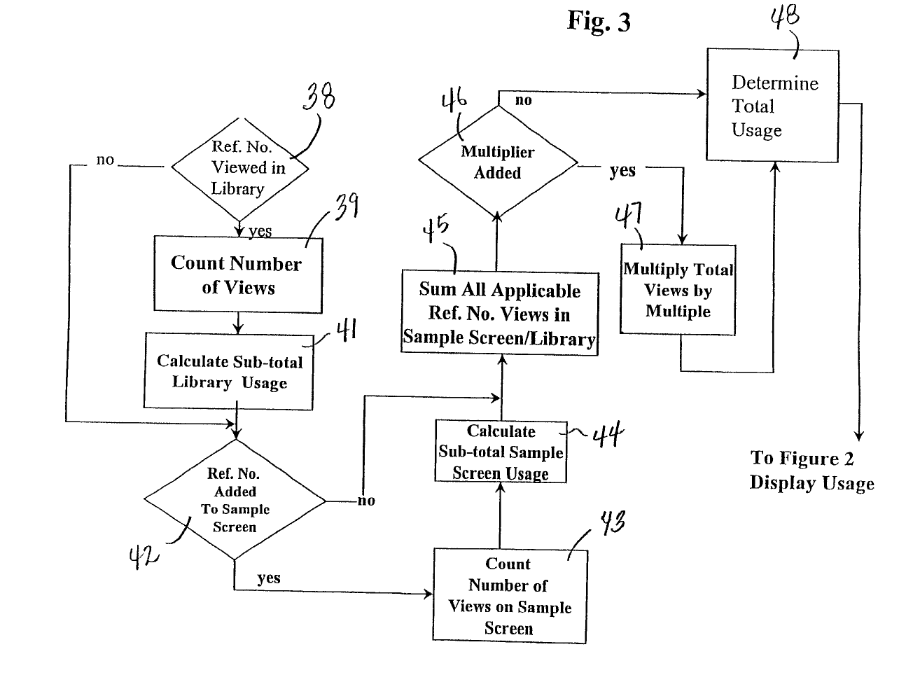

Usage calculation is described in the flow chart of FIG. 3. Each time a participant's entry is viewed in the library, as indicated at 38, credit is given to the associated reference number and the credits totaled at 39. The library usage subtotal is then calculated at 41. If the entry was posted for sample screen viewing, as indicated at 42, the usage on the sample screen is tracked and counted at 43. This usage is calculated to obtain a further viewing subtotal at 44. The library usage and sample screen usage is then summed at 45. If the user purchased a multiplier, as indicated at 46, then the usage sum is multiplied at 47 by the selected multiplier to give a total usage for the reference number at 48. The total usage for each entry is available for display on the Web site at 51 (See FIG. 2).

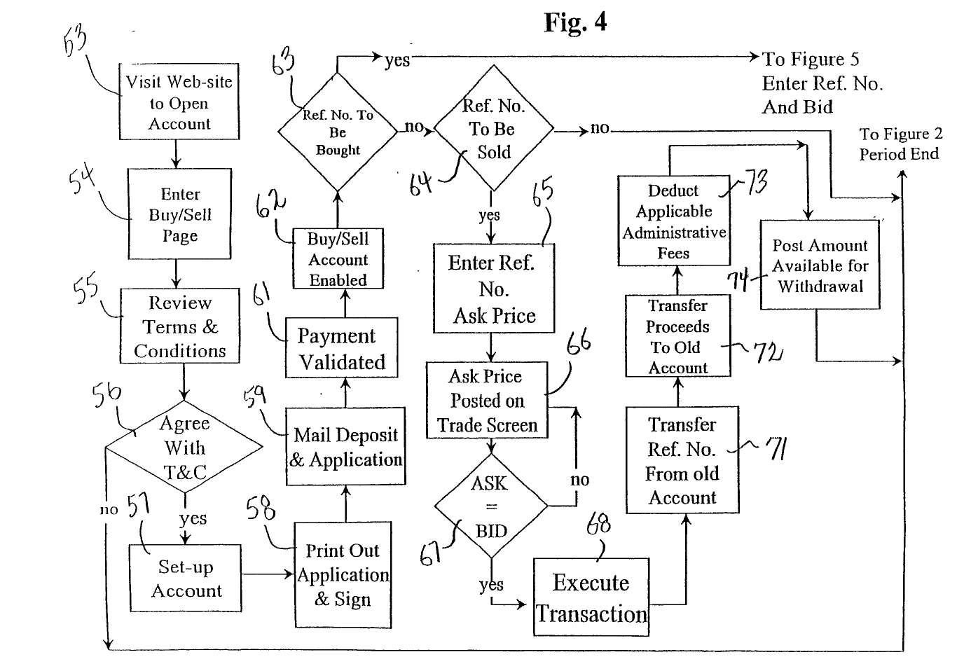

Entries on the Web site may be purchased and sold by any participant, as indicated at 52. FIG. 4 illustrates the process of buying/selling an entry. A prospective purchaser/seller (“user”) visits the Web site, and opens an account at 53. The user enters a buy/sell page at 54, and reviews applicable terms and conditions at 55. If the terms and conditions are accepted, as indicated at 56, the user account is opened at 57 and an application form printed out at 58 and mailed by the user at 59 together with a deposit to a specified address. Once payment is validated at 61, the buy/sell account is enabled at 62. The user may then offer to either buy or sell a reference number associated with a particular entry, as indicated at 63 and 64, respectively. If the user chooses to sell a reference number, he or she enters an asking price at 65 which is posted on a trade screen at 66. When a bid price matches the asking price, as indicated at 67, a transaction is executed at 68 transferring ownership of the reference number from the sellers account to the new buyers account at 71. The proceeds from the sale are then transferred at 72 to the sellers account. Administrative fees are deducted from this account at 73, and an amount available for withdrawal is posted at 74.

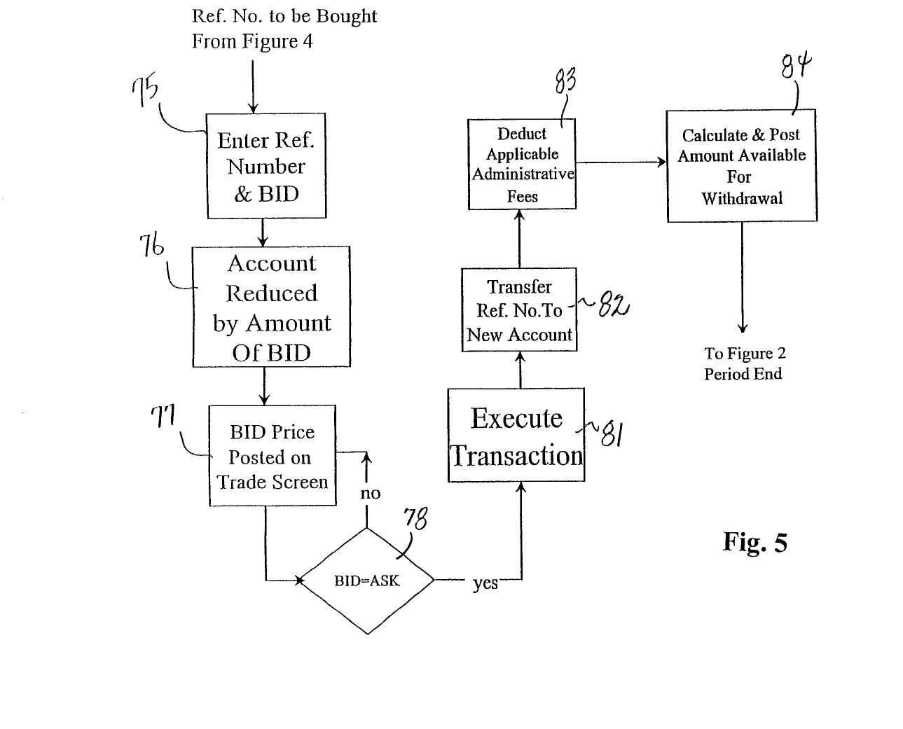

If, instead of selling, the user desired to purchase a reference number, he or she enters a reference number bid, as indicated in FIG. 5 at 75. The user's account is reduced at 76 by the amount of the bid, and the bid price posted on the trade screen at 77. If the bid price equals the asking price, as indicated at 78, a transaction is executed at 81 transferring ownership of the reference number to the buyer. The reference number is transferred to the buyer's account at 82. Administrative fees are deducted from this account at 83, and an amount available for withdrawal is posted at 84.

Referring back to FIG. 2, at the end of the fixed period, as indicated at 85, all reference numbers are ranked according to usage and payouts calculated at 86 for eligible participants making the top 100. Payouts are issued at 87 until the available payout fund for the present period is exhausted. For those eligible participants who fail to receive a payout due to insufficiency of the payout fund, their usage is automatically rolled over at 88 to the succeeding period. Usage for participants not making the top 100 is reset to zero at 91. If a multiplier for a given reference number is expired, as indicated at 92, then the multiplier is disabled at 93. Usage calculation for the succeeding period resumes at 94.

In a further embodiment, users may elect to purchase from the system administrator an entire category of entries posted on the Web site. In this case, a certain percentage of revenue generated by entries within this category would be paid to the owner of the category. Alternatively, users may elect to purchase only a percentage of ownership of a particular category.

An information Web site with usage-based payout to participants is described above. Various details of the invention may be changed without departing from its scope. Furthermore, the foregoing description of the preferred embodiment of the invention and the best mode of practicing the invention are provided for the purpose of illustration only and not for the purpose of limitation-the invention being defined by the claims.

I claim:

1. An electronic system for rewarding participants posting entries on an Internet Web site, said system comprising:
(a) a Web page comprising participant entries adapted for being accessed and viewed by visitors of the Web site;
(b) means for ranking the entries based on preference criteria determined by said system; and
(c) means for determining which participants are eligible for a reward based on their entry ranking relative to other entries posted on the Web site.

2. An electronic system according to claim 1, wherein the participant entry comprises a text submission.

3. An electronic system according to claim 1, wherein the participant entry comprises a photograph.

4. An electronic system according to claim 1, wherein the participant entry comprises a combination of text and a photograph.

5. An electronic system according to claim 1, wherein the reward comprises a cash payout.

6. An electronic system according to claim 1, wherein the reward comprises a prize item.

7. An electronic system for rewarding participants posting entries on an Internet Web site, said system comprising:
(a) a Web page comprising participant entries adapted for being accessed and viewed by visitors of the Web site;
(b) means for ranking the entries based on preference criteria determined by said system, said preference criteria comprising entry usage over a fixed period; and
(c) means for determining which participants are eligible for a reward based on their entry ranking relative to other entries posted on the Web site.

8. An electronic system according to claim 7, and comprising a multiplier available for purchase by the participant to increase effective usage of the entry during the fixed period.

9. An electronic system according to claim 7, and comprising a sample entry screen on the Web site including a listing of both sample entries and actual participant entries.

10. An electronic system for rewarding participants posting entries on an Internet Web site, said system comprising:
(a) a Web page comprising participant entries adapted for being accessed and viewed by visitors of the Web site;
(b) means for ranking the entries based on preference criteria determined by said system, said preference criteria comprising entry usage over a fixed period; and
(c) means for determining which participants rank in the top 100 for entry usage during the fixed period, whereby those participants ranking in the top 100 are eligible for a reward based on their entry ranking relative to other entries posted on the Web site.

11. A method for rewarding participants posting entries on an Internet Web site, said method comprising the steps of:
(a) providing a Web page comprising participant entries adapted for being accessed and viewed by visitors of the Web site;
(b) ranking the entries based on predetermined preference criteria; and
(c) rewarding certain participants based on their entry ranking relative to other entries posted on the Web site.

12. A method according to claim 11, and comprising collecting a posting payment from participants posting entries on the Web site.

13. A method according to claim 12, wherein the step of ranking the entries comprises ranking the entries based on entry usage over a fixed period

14. A method according to claim 13, and comprising displaying the usage for each entry at the Web site.

15. A method according to claim 13, and comprising grouping the entries into subject matter categories.

16. A method according to claim 15, and comprising displaying the usage for each category of entries at the Web site.

17. A method according to claim 13, and comprising making those participants with entries ranking in the top 100 for usage eligible for receiving a reward.

18. A method according to claim 17, and comprising allocating a percentage of the posting payment to a payout fund used for rewarding those participants eligible for receiving a reward during a given period.

19. A method according to claim 18, wherein the step of rewarding participants comprises rewarding certain ones of those participants with entries ranking in the top 100 for usage with a sum-certain cash payout from the payout fund until the payout fund is emptied.

20. A method according to claim 19, and comprising automatically carrying forward to a succeeding period those participants ranking in the top 100 for usage during a present period and not receiving a cash payout.

21. A method according to claim 13, and comprising purchasing a multiplier to increase the overall usage of an entry.

22. A method according to claim 13, and comprising posting the entry on a sample entry screen to increase overall usage.

23. A method for rewarding participants posting entries on an Internet Web site, said method comprising the steps of:
(a) collecting a posting payment from participants;
(b) posting participant entries on a Web page adapted for being accessed and viewed by visitors of the Web site;
(c) ranking the entries based on predetermined preference criteria, the preference criteria comprising entry usage over a fixed period;
(d) making certain ones of the participants eligible for receiving a cash payout based on a level of their entry usage during the fixed period;
(e) allocating a percentage of the posting payment to a payout fund used for rewarding those participants eligible for receiving the payout;
(f) distributing the cash payout to eligible participants until the payout fund for the fixed period is emptied; and.
(g) for those participants eligible for receiving the payout but not receiving the payout due to insufficiency of the payout fund, automatically carrying those participants forward to a succeeding period.
